(19) United States
(12) Patent Application Publication
(10) Pub. No.: US 2009/0325783 A1
(43) Pub. Date: Dec. 31, 2009

(54) OTO QUENCH TOWER CATALYST RECOVERY SYSTEM UTILIZING A LOW TEMPERATURE FLUIDIZED DRYING CHAMBER

(76) Inventors: Daniel N. Myers, Arlington Heights, IL (US); Richard A. Johnson, II, Algonquin, IL (US); Andrea G. Bozzano, Northbrook, IL (US)

Correspondence Address: HONEYWELL/UOP;PATENT SERVICES, 101 COLUMBIA DRIVE, P O BOX 2245 MAIL STOP AB/2B, MORRISTOWN, NJ, 07962, US

(21) Appl. No.: 12/164,344

(22) Filed: Jun. 30, 2008

(51) Int. Cl. B01J 20/34; B01J 8/00

(52) U.S. Cl. 502/22; 422/187

(57) ABSTRACT

Systems and methods for recovering catalyst in an oxygenate to olefin process are provided that include removing a quench tower bottoms stream containing catalyst from a quench tower and passing the catalyst containing stream to a drying chamber, where the catalyst containing stream is dried to produce substantially dried catalyst.

### TECHNICAL FIELD

This disclosure relates to systems and methods for catalyst recovery in oxygenate to olefin (OTO) processes.

### DESCRIPTION OF RELATED ART

Olefins can be produced from hydrocarbon feedstocks, such as petroleum or oxygenates, through various processes, including catalytic conversion or steam cracking processes. Light olefins, such as ethylene and/or propylene, are particularly desirable olefin products because they are useful for making plastics and other chemical compounds. For example, ethylene can be used to make various polyethylene plastics, and in making other chemicals such as vinyl chloride, ethylene oxide, ethylbenzene and alcohol. Propylene can be used to make various polypropylene plastics, and in making other chemicals such as acrylonitrile and propylene oxide.

Oxygenate feedstocks are particularly attractive for use in producing olefins because they are available from a variety of materials, including coal, natural gas, recycled plastics, various carbon waste streams from industry, and various products and by-products from the agricultural industry.

Oxygenate to olefin (OTO) conversion processes are generally based upon conversion of the oxygenate feedstock to an olefin containing effluent stream in a catalytic reactor that includes a catalyst reaction zone. The catalyst contained in the catalytic reaction zone can be a molecular sieve catalyst or a molecular sieve catalyst composition. Molecular sieve catalyst compositions can include molecular sieve, binder and/or matrix material.

Catalytic reactors can also contain separation zones, which include separation devices such as cyclones, to prevent catalyst from exiting the catalytic reactor. Nonetheless, catalyst particles, particularly smaller particles known as catalyst fines, are generally contained within the effluent stream that leaves the catalytic reactor.

The effluent stream from the catalytic reactor is generally passed to a wash unit, or quench unit. In the quench device, the effluent stream from the catalytic reactor is contacted with a quench liquid. A vapor product stream is produced that contains light olefin products, and the vapor product stream is passed through the further process steps to separate the desired products. A bottoms stream is also produced in the quench device. The bottoms stream can contain heavier olefin products, water, and catalyst particles.

### SUMMARY

The methods and systems disclosed herein relate to the recovery of catalyst particles from an effluent stream from a catalytic reactor in an OTO process. More particularly, the disclosed methods and systems relate to the recovery of catalyst particles from the bottoms stream of a quench unit.

In one aspect, a method for recovering catalyst in an oxygenate to olefin process is provided that includes: removing a quench tower bottoms stream containing catalyst from a quench tower, separating the quench tower bottoms stream to provide a substantially clarified liquid and a catalyst containing stream, passing the catalyst containing stream to a drying chamber, and drying the catalyst containing stream in the drying chamber to produce substantially dried catalyst. The method can include storing the catalyst containing stream in a recovered catalyst storage tank prior to passing the catalyst containing stream to a drying chamber. The method can also include recovering water vapor from the drying chamber, and discharging the water vapor to the catalyst regenerator above the catalyst in the regenerator. In at least one example, the method includes passing the substantially dried catalyst to a catalyst regenerator, and regenerating the substantially dried catalyst.

In another aspect, a method for recovering catalyst in an oxygenate to olefin process is provided that includes: providing a catalyst containing stream recovered from a quench tower bottoms stream, passing the catalyst containing stream to a drying chamber having a temperature of from about 150° C. (about 302° F.) to about 250° C. (about 482° F.), drying the catalyst containing stream in the drying chamber to produce water vapor and substantially dried catalyst, passing the substantially dried catalyst to a catalyst regenerator, and discharging the water vapor to the catalyst regenerator above the catalyst in the regenerator.

In a third aspect, a system for recovering catalyst in an oxygenate to olefin process is provided that includes: a quench tower that receives a catalytic reactor effluent stream and produces a quench tower bottoms stream containing catalyst; at least one liquid cyclone that receives the quench tower bottoms stream and produces a substantially clarified liquid and a catalyst containing stream, a drying chamber that receives the catalyst containing stream and produces a substantially dried catalyst, and a catalyst regenerator that receives the substantially dried catalyst.

### BRIEF DESCRIPTION OF THE DRAWINGS

Specific examples have been chosen for purposes of illustration and description, and are shown in the accompanying drawing, forming a part of the specification.

FIG. 1 is a simplified schematic diagram of one example of a process for recovering catalyst.

### DETAILED DESCRIPTION

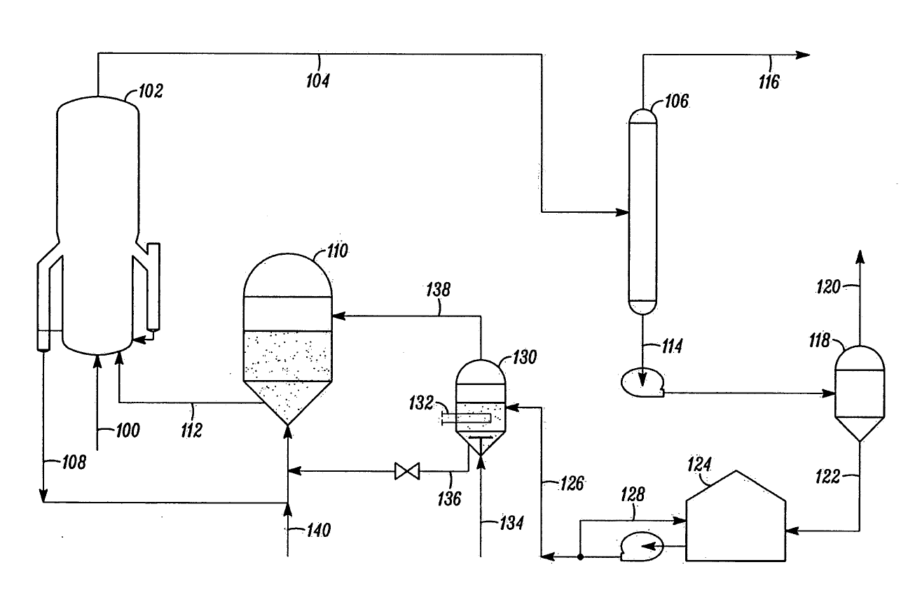

A schematic diagram of one example of a process for the recovery of catalyst is illustrated in FIG. 1. In the illustrated example, an oxygenate feedstock 100 is provided to a catalytic reactor 102.

The oxygenate feedstock 100 can be any suitable feedstock. Oxygenate feedstocks generally include one or more organic compound(s) containing at least one oxygen atom. Oxygenate feedstocks can be, for example, alcohols, aliphatic alcohols, methanol, ethanol, n-propanol, isopropanol, methyl ethyl ether, dimethyl ether, diethyl ether, di-isopfopyl ether, formaldehyde, dimethyl carbonate, dimethyl ketone, acetic acid, and mixtures thereof. Methanol is a particularly preferred oxygenate feedstock, and processes for converting methanol to olefins are generally referred to as being MTO processes.

The oxygenate feedstock 100 can be a liquid, a vapor, or a combination thereof. The oxygenate feedstock 100 can be a heated oxygenate feedstock that has undergone heating steps, such as indirect heat exchange with the reactor effluent stream or other process streams, prior to being introduced to the catalytic reactor 102. The oxygenate feedstock 100 can also contain one or more diluents, including, but not limited to, helium, argon, nitrogen, carbon monoxide, carbon dioxide, water, essentially non-reactive paraffins (including, for example, alkanes such as methane, ethane, and propane), essentially non-reactive aromatic compounds, and mixtures thereof.

Catalytic reactor 102 can be any catalytic reactor suitable for use in an OTO process, including, for example, fixed bed reactors, fluidized bed reactors, hybrid reactors, and riser reactors. Catalytic reactor 102 can include a single zone or multiple zones, and preferably includes a reaction zone containing catalyst and a separation zone. The catalyst contained in catalytic reactor 102 can be any catalyst suitable for use in an OTO process, and is preferably a molecular sieve. Molecular sieve catalysts include, for example, AEI, AFT, APC, ATN, ATT, ATV, AWW, BIK, CAS, CHA, CHI, DAC, DDR, EDI, ERI, GOO, KFI, LEV, LOV, LTA, MON, PAU, PHI, RHO, ROG, THO, AFO, AEL, EUO, HEU, FER, MEL, MFI, MTW, MTT, TON, EMT, FAU, ANA, BEA, CFI, CLO, DON, GIS, LTL, MER, MOR, MWW and SOD and substituted forms thereof. Preferred molecular sieve catalysts include zeolites, aluminophosphate (ALPO) molecular sieves, and silicoaluminophosphate (SAPO) molecular sieves, as well as substituted forms thereof.

In catalytic reactor 102, the oxygenate feedstock 100 is subjected to reaction conditions suitable for producing the desired level of catalytic conversion and produce an olefin containing reactor effluent stream 104. In some examples, the reaction temperature can be from about 200° C. (about 392° F.) to about 700° C. (about 1292° F.), preferably from about 250° C. (about 482° F.) to about 600° C. (about 1112° F.), and more preferably from about 300° C. (about 572° F.) to about 500° C. (about 932° F.). The reaction pressure can be any suitable pressure, including autogeneous pressures, and can preferably be from about 0.1 kPa (about 0.01 psi) to about 5 MPa (about 725 psi), more preferably from about 5 kPa (about 0.725 psi) to about 1 MPa (about 145 psi), and most preferably from about 20 kPa (about 2.9 psi) to about 500 kPa (about 72.5 psi). The term reaction pressure refers to the partial pressure of the feed as it relates to oxygenate compounds and/or mixtures thereof, and does not include the partial pressure of the diluent, if any. The WHSV for the oxygenate conversion reaction, defined as weight of total oxygenate to the reaction zone per hour per weight of molecular sieve in the catalyst in the reaction zone, is another factor that can be varied in the catalytic reactor 102. The total oxygenate to the reaction zone includes all oxygenate in both the;vapor and liquid phase. Although the catalyst may contain other materials which act as inerts, fillers or binders, the WHSV is generally calculated using only the weight of molecular sieve in the catalyst in the reaction zone. The WHSV is preferably high enough to maintain the catalyst in a fluidized state under the reaction conditions and within the reactor configuration and design. Preferably, the WHSV can be from about 1 hr⁻¹ to about 5000 hr⁻¹, more preferably from about 2 hr⁻¹ to about 3000 hr⁻¹, and most preferably from about 2 hr⁻¹ to about 1500 hr⁻¹. The oxygenate conversion rate can be any suitable conversion rate, and is preferably maintained sufficiently high to avoid the need for commercially unacceptable levels of feed recycling. Preferably, the oxygenate conversion rates can be from about 50% to about 100%, more preferably from about 95% to about 100%.

During the conversion process within the catalytic reactor 102, carbonaceous deposits, referred to as “coke,” build up on the catalyst. Catalyst that has a buildup of such carbonaceous deposits becomes less effective, and is referred to as being spent. Periodically, or continuously, all or a portion of the spent catalyst can be removed from the catalytic reactor 102 in a spent catalyst stream 108, and passed to a catalyst regenerator 110. Spent catalyst stream can be passed to the catalyst regenerator 110 by any suitable mechanism, including, for example, an air lift. In one example, the spent catalyst stream 108 can be combined with lift medium 140, which is preferably air, and can then be passed to the catalyst regenerator 110.

In the regenerator 110, the spent catalyst is contacted with a regeneration medium, preferably a gas containing oxygen, under suitable regeneration conditions to remove, or “burn off,” the carbonaceous deposits and produce regenerated catalyst. Regenerated catalyst can be passed back to the catalytic reactor 102 in regenerated catalyst stream 112. In some examples, the regenerated catalyst is cooled prior to entering the catalytic reactor 102.

Suitable regeneration conditions can include a regeneration temperature, a regeneration pressure, and a residence time. The regeneration medium can include one or more gases such as, for example, oxygen, O₃, SO₃, N₂O, NO, NO₂, N₂O₅, air, air diluted with nitrogen or carbon dioxide, oxygen and water, carbon monoxide, hydrogen, or mixtures thereof. The regeneration temperature can, for example, be in the range of from about 200° C. (about 392° F.) to about 1500° C. (about 2732° F.), preferably from about 300° C. (about 572° F.) to about 1000° C. (about 1832° F.), more preferably from about 450° C. (about 842° F.) to about 750° C. (about 1382° F.), and most preferably from about 550° C. (about 1022° F.) to 700° C. (about 1292° F.). The regeneration pressure can be in the range of from about 15 psia (103 kPaa) to about 500 psia (3448 kPaa), preferably from about 20 psia (138 kPaa) to about 250 psia (1724 kPaa), more preferably from about 25 psia (172 kPaa) to about 150 psia (1034 kPaa), and most preferably from about 30 psia (207 kPaa) to about 80 psia (551 kPaa). The preferred residence time of the catalyst in the regenerator 110 is in the range of from about one minute to several hours, most preferably about one minute to 100 minutes. In some examples, regeneration promoters or fresh (not spent) catalyst, can also be added to the regenerator 110, either directly or indirectly, for example with the spent catalyst. Regeneration promoters can include, but are not limited to, metal containing compounds such as platinum, palladium and the like.

Referring back to FIG. 1, a reactor effluent stream 104 exits the reactor and can be passed to a quench unit, such as quench tower 106. The reactor effluent stream 104 can undergo other process steps prior to being passed to the quench tower 106, such as undergoing being cooled by direct or indirect heat exchange with the oxygenate feedstock 100 or another cooling stream. The reactor effluent stream 104 can contain several elements, including, but not limited to, unreacted oxygenate feedstock, olefin products, water, and catalyst particles. The majority of the catalyst particles in the reactor effluent stream are catalyst fines, having a particle size of about 40 microns or less, particularly when the catalytic reactor 102 has a separation zone to promote maintaining catalyst within the reactor.

A “quench unit” or “quench tower” can be any device in which the reactor effluent stream 104 is contacted with at least one quench liquid to produce an olefin containing vapor effluent stream 116 and a bottoms stream 114. A preferred quench liquid is water. In the quench tower 106, a portion of the reactor effluent stream 104 condenses and becomes part of the bottoms stream 114. The bottoms stream 114 generally contains some olefins, water, and catalyst particles. For example, the bottoms stream 114 can contain water, unreacted oxygenate feedstock, and oxygenate conversion byproducts such as heavy hydrocarbons, which are generally defined as being C₅ hydrocarbons or greater. The portion of the reactor effluent stream 104 that remains in a gaseous or vapor state in the quench tower 106 becomes olefin containing vapor effluent stream 116, which exits the quench tower 106 and can undergo further processing, and can be separation into various olefin products, such as, for example ethylene and propylene. For example, the olefin containing vapor effluent stream 116 can include light olefins, dimethyl ether, methane, carbon monoxide (CO), carbon dioxide (CO₂), ethane, and propane, as well as any water and unreacted oxygenate feed stream that is not condensed in the quench tower 106.

Quench tower 106 as illustrated in FIG. 1 is a single stage unit having a single vapor effluent stream and a single bottoms stream. In alternative examples, the reactor effluent stream can be passed to a quench process that includes multiple stages or multiple units, and can result in the generation of multiple bottoms streams. In such examples, the first bottoms stream generally contains the bulk of the catalyst particles. The first bottoms stream, either alone or in combination with other bottoms streams removed from the quench process, can undergo the process described herein for removal and recovery of the catalyst particles contained therein.

The quench tower bottoms stream 114 containing catalyst can be removed from the quench tower 106. The quench tower bottoms stream 114 can be passed or pumped to a separating unit 118 to be separated, providing a substantially clarified liquid 120 and a catalyst containing stream 122. The separating unit can be, for example, at least one settling tank or at least one liquid cyclone. Catalyst containing stream 122 contains catalyst particles and water, and can contain other elements. The catalyst containing stream 122 preferably contains catalyst in an amount from about 10% by weight to about 50% by weight, from about 10% by weight to about 25% by weight, or from about 15% by weight to about 30% by weight. It is preferred that the weight percentage of the catalyst in catalyst containing stream 122 be as high as possible, to reduce the amount of water that needs to be removed, but the flowability of catalyst containing stream 122 tends to be reduced as the catalyst content increases. Accordingly, in some examples, the catalyst containing stream 122 can contain catalyst in an amount of about 25% by weight, up to about 25% by weight, or greater than about 25% by weight.

In the example illustrated in FIG. 1, the catalyst containing stream can be stored in a recovered catalyst storage tank 124 prior to being passed to the drying chamber 130. Alternatively, the catalyst containing stream 122 can be passed directly or indirectly from the separating unit 118 to a drying chamber 130. Utilization of recovered catalyst storage tank 124 facilitates the accumulation of a desired volume of catalyst containing stream recovered from the separating unit, and provides flexibility regarding the timing of operation of catalyst recovery steps downstream of the separating unit 118. Recovered catalyst storage tank 124 can have a circulation loop 128, where the catalyst containing stream is pumped out of the recovered catalyst storage tank 124 and then discharged back into the recovered catalyst storage tank 124. Circulation loop 128 can be useful to reduce or prevent settling of the catalyst containing stream in the recovered catalyst storage tank 124.

As illustrated in FIG. 1, catalyst containing stream 126 is passed to at least one drying chamber 130. The catalyst containing stream is dried in the drying chamber 130 to produce substantially dried catalyst. The catalyst drying chamber 130 can be any type of chamber suitable for drying the catalyst, and is preferably a fluidized bed. Gas stream 134 can be a fluidizing medium for drying chamber 130. Gas stream 134 can be air, preferably dry air, or any other suitable gas, such as, for example, nitrogen. The drying chamber 130 can be heated by heating coils 132 that contain a heating medium such as steam or oil. Steam coils are a particularly preferred type of heating coil. Alternatively, gas stream 134 can be a heated gas stream, and can be used to heat drying chamber 130. The drying chamber is preferably heated to a temperature that is sufficient to dry the catalyst, but that is less than the temperature of a catalyst regenerator. For example, drying chamber 130 preferably has a temperature of from about 150° C. (about 302° F.) to about 250° C. (about 482° F.), more preferably from about 150° C. (about 302° F.) to about 200° C. (about 392° F.).

Without being bound by any particular theory, it is believed that directly discharging wet catalyst containing stream 122 or 126 into a catalyst regenerator 110 can cause hydrothermal catalyst deactivation, and thus be detrimental to the catalyst activity of the catalyst in the regenerator 110. Further, it is believed that the thermal shocking of the wet catalyst caused by directly discharging the wet catalyst to the regenerator 110 can cause particle breakup and loss of the catalyst, thus reducing the ability to effectively recover catalyst particles from the quench tower 106.

The drying chamber 130 preferably removes water from the catalyst containing stream 126, and produces a substantially dried catalyst. The substantially dried catalyst can contain a residual water or moisture content, but the amount of water within the substantially dried catalyst is preferably minimal. Water is preferably removed from the catalyst in the drying chamber 130, such as by evaporation, and water vapor is produced that can be removed or recovered from the drying chamber 130. Water vapor can be recovered from drying chamber 130 in water vapor stream 138. Water vapor stream 138 can be removed from the system, or utilized at any suitable location within the system. As shown in FIG. 1, water vapor stream 138 is discharged to the catalyst regenerator 110 at a location above the catalyst in the regenerator 110. Discharging the water vapor stream 138 to the regenerator 110 may facilitate recovery of any catalyst particles that are contained in water vapor stream 138.

The substantially dried catalyst produced in drying chamber 130 can be passed to the catalyst regenerator 110. The substantially dried catalyst is preferably regenerated in regenerator 110, along with spent catalyst removed directly from the catalytic reactor 102, and returned to the catalytic reactor in regenerated catalyst stream 112. As illustrated in FIG. 1, substantially dried catalyst stream 136 is removed from the drying chamber 130 and can be combined with spent catalyst stream 108, which is then passed to regenerator 110. For example, substantially dried catalyst stream 136 can be passed to a lift riser (not shown) that utilizes lift medium 140 to lift the dried catalyst stream 136 and the spent catalyst 108 taken from the catalytic reactor 102 to the regenerator 110. Alternatively, substantially dried catalyst stream 136 can be passed directly from the drying chamber 130 to the regenerator 110. In another alternative, the substantially dried catalyst can be passed from the drying chamber 130 directly or indirectly to the catalytic reactor 102, without first going through catalyst regenerator 110. In such instances, the gas stream 14 can be a nitrogen stream, or dried catalyst stream 136 can be passed to a stripper utilizing a nitrogen stream, to prevent oxygen from entering the reactor 102.

Substantially dried catalyst stream 136 can be removed from drying chamber 130 by any suitable method. In one example, the strength or flow rate of the gas stream 134 can be periodically increased to lift or push substantially dried catalyst out of the drying chamber 130.

From the foregoing, it will be appreciated that although specific examples have been described herein for purposes of illustration, various modifications may be made without deviating from the spirit or scope of this disclosure. It is therefore intended that the foregoing, detailed description be regarded as illustrative rather than limiting, and that it be understood that it is the following claims, including all equivalents, that are intended to particularly point out and distinctly claim the claimed subject matter.

What is claimed is:

1. A method for recovering catalyst in an oxygenate to olefin process, the method comprising:
removing a quench tower bottoms stream containing catalyst from a quench tower;
separating the quench tower bottoms stream to provide a substantially clarified liquid and a catalyst containing stream;
passing the catalyst containing stream to a drying chamber; and
drying the catalyst containing stream in the drying chamber to produce substantially dried catalyst.

2. The method of claim 1, further comprising:
storing the catalyst containing stream in a recovered catalyst storage tank prior to passing the catalyst containing stream to a drying chamber.

3. The method of claim 1, further comprising:
passing the substantially dried catalyst to a catalyst regenerator; and
regenerating the substantially dried catalyst.

4. The method of claim 1, wherein the step of separating is conducted in at least one liquid cyclone.

5. The method of claim 1, wherein the catalyst containing stream contains from about 10% by weight to about 50% by weight catalyst.

6. The method of claim 1, the drying chamber has a temperature of from about 150° C. to about 250° C.

7. The method of claim 1, wherein the drying chamber is heated by heating coils.

8. The method of claim 1, wherein the drying chamber is a fluidized bed.

9. The method of claim 1, further comprising:
recovering water vapor from the drying chamber; and
discharging the water vapor to the catalyst regenerator above the catalyst in the regenerator.

10. The method of claim 1, wherein the substantially dried catalyst is passed to the regenerator by passing the substantially dried catalyst to a lift riser that also lifts spent catalyst from a catalytic reactor to the regenerator.

11. A method for recovering catalyst in an oxygenate to olefin process, the method comprising:
providing a catalyst containing stream recovered from a quench tower bottoms stream;
passing the catalyst containing stream to a drying chamber having a temperature of from about 150° C. to about 250° C.;
drying the catalyst containing stream in the drying chamber to produce water vapor and substantially dried catalyst;
passing the substantially dried catalyst to a catalyst regenerator; and
discharging the water vapor to the catalyst regenerator above the catalyst in the regenerator.

12. The method of claim 11, wherein the drying chamber is a fluidized bed heated by heating coils.

13. The method of claim 11, further comprising:
removing a quench tower bottoms stream containing catalyst from a quench tower;
separating the quench tower bottoms stream to provide a substantially clarified liquid and a catalyst containing stream; and
storing the catalyst containing stream in a recovered catalyst storage tank prior to passing the catalyst containing stream to a drying chamber.

14. The method of claim 13, wherein the step of separating is conducted in at least one liquid cyclone.

15. The method of claim 11, wherein the catalyst containing stream contains from about 10% by weight to about 50% by weight catalyst.

16. The method of claim 11, wherein the substantially dried catalyst is passed to the regenerator by passing the substantially dried catalyst to a lift riser that also lifts spent catalyst from a catalytic reactor to the regenerator.

17. A system for recovering catalyst in an oxygenate to olefin process, the system comprising:
a quench tower that receives a catalytic reactor effluent stream and produces a quench tower bottoms stream containing catalyst;
at least one liquid cyclone that receives the quench tower bottoms stream and produces a substantially clarified liquid and a calatyst containing stream;
a drying chamber that receives the catalyst containing stream and produces a substantially dried catalyst; and
a catalyst regenerator that receives the substantially dried catalyst.

18. The system of claim 17, wherein the drying chamber is a heated fluidized bed having a temperature of from about 150° C. to about 250° C.

19. The system of claim 17, wherein the substantially dried catalyst is passed to the regenerator by passing the substantially dried catalyst to a lift riser that also lifts spent catalyst from a catalytic reactor to the regenerator.

20. The system of claim 17, wherein the drying chamber further produces water vapor that is discharged into the regenerator at a location above the catalyst in the regenerator.
